(19) United States
(12) Patent Application Publication
(10) Pub. No.: US 2012/0216011 A1
(43) Pub. Date: Aug. 23, 2012

(54) APPARATUS AND METHOD OF SINGLE-INSTRUCTION, MULTIPLE-DATA VECTOR OPERATION MASKING

(76) Inventors: Darryl Gove, Sunnyvale, CA (US); David Weaver, Emerald Hills, CA (US)

(21) Appl. No.: 13/030,515

(22) Filed: Feb. 18, 2011

(51) Int. Cl. G06F 15/76; G06F 9/30

(52) U.S. Cl. 712/7; 712/E09.016

(57) ABSTRACT

An apparatus, method, and medium for performing a vector operation on portions of one or more source vector registers. A vector unit performs an operation on the source vector registers and only stores results in the target vector register for elements which are selected by the vector operation mask. The vector operation mask can be read by the vector unit or loaded into the vector unit for each instruction cycle. The vector operation mask allows the vector unit to be used with partially filled source vector registers and eliminates the need for scalar operations to be performed on vector data.

### BACKGROUND OF THE INVENTION

1. Field of the Invention

This disclosure relates generally to computer processors, and in particular to an apparatus and method for masking vector operations during the execution of a single-instruction, multiple-data (SIMD) vector instruction.

2. Description of the Related Art

Increased processor performance may be attained when programs are structured to execute instructions concurrently. This increased processor performance is crucial for computationally intensive tasks. This type of parallel processing is often referred to as vector processing. A vector processor is an ensemble of hardware resources, including vector registers, functional pipelines, and processing elements, for performing vector operations. Vector processing occurs when arithmetic or logical operations are applied to vectors, which are sets of scalar data items, all of the same type. Vector processing takes advantage of operations that tend to repeat the same set of basic operations over a large input dataset by executing an instruction on multiple data elements. A scalar processing unit, on the other hand, can operate on only one data element at a time.

A prior art example of a scalar processing unit 100 is shown in FIG. 1A. The operation being performed is an addition of r1 and r2 to provide a result of r3 (i.e., r3=r1+r2). An example of a vector processing unit 150 is shown in FIG. 1B. The operation being performed is a vector addition involving ‘N’ data elements (i.e., v3[i]=v1[i]+v2[i], wherein ‘i’ takes on values from 1 to ‘N’).

Vector operations are often used to increase the efficiency of a processor. For example, in operations that are performed repeatedly without any correlation between the data elements, vector operations can be used to perform multiple operations each clock cycle. This can speed up the processing as compared to conventional scalar processing where one operation is performed each clock cycle.

The actual implementation of a vector processing unit must deal with certain complexities. For example, the incoming vector data does not always line up to fill the entire source vector register. For an incomplete register, a typical means of processing may involve executing a prologue loop to process the individual data elements one at a time in a scalar fashion. For example, if the vector register has a capacity of 32 elements, and 63 elements are to be processed, the prologue loop may have to process the first 31 elements before the vector operation can be used to process the remaining 32 elements. Also, at the end of an input data stream, any leftover data elements that do not fill a full vector register will typically be processed one at a time in an epilogue loop.

The scalar prologue and epilogue loops require extra processing time and reduce the efficiency of vector processing techniques. Also, software executing in the vector processing unit is often unwieldy and complex due to the different cases it must handle. Dealing with misaligned data and partially filled source vector registers unnecessarily complicates the software. Software needs special cases and if-then statements to deal with the different scenarios for when the source vector register does not contain enough data to perform a full vector instruction.

As the size of the vector processing unit increases, the average number of iterations of the prologue and epilogue scalar loops will also increase. The time spent performing vector operations on full registers may end up being small compared with the time spent processing partially filled registers with a scalar approach. What is needed is a technique to allow the vector processing unit to process incoming data elements regardless of the size or number of elements, and whether or not the elements entirely fill up the source vector register. Such a technique may reduce the amount of prologue and epilogue code required, reduce the amount of power consumed by the vector processing unit, and eliminate the need for dedicated scalar operations on the vector registers.

In view of the above, improved methods and apparatus for masking vector operations are desired.

### SUMMARY OF THE INVENTION

Various embodiments of methods and apparatus for utilizing a vector operation mask to perform single-instruction, multiple data (SIMD) operations are contemplated. In one embodiment, one or more source vectors may include a plurality of data elements, and each data element may be operated on within a lane of a vector unit. A lane may refer to a portion of a computation unit which operates on an element of a source register. The vector unit may include a plurality of lanes and a plurality of computing units to operate on the data elements of the source vectors. A vector operation mask may include an indicator for each data element of the source vectors, and this mask may be encoded in a register. The vector operation mask identifies some vector elements as “selected” and the remainder as “deselected” for use in a vector operation.

The vector operation mask may be implemented to allow a vector unit to process partially filled source vector registers or portions of a source vector register. In various embodiments, if a source vector register is only partially filled with relevant data elements, for each element in the source vector register that is not filled with relevant data the vector operation mask may include an identification of these elements as deselected. The vector unit may then ignore the deselected elements for purposes of computation. In some embodiments, individual computing units of the vector unit which are associated with deselected elements of a source vector register may be turned off to reduce power consumption.

In some embodiments, the deselected or “don't care” elements may be processed by the vector unit, but the results of operations based on deselected elements may be ignored, not written to the target vector register, or otherwise discarded. In various embodiments in which exceptions may be raised, exceptions corresponding to deselected elements may be ignored. In this manner, the vector operation mask may prevent particular operations from being flagged as exceptions for deselected elements.

In some embodiments, the vector operation mask may include a separate indicator (e.g., one or more bits) corresponding to each element in a source vector register. In other embodiments, indicators in the vector operation mask may correspond to more than one element in a source vector register. In some embodiments, the vector operation mask may be passed to the vector unit as an input during each instruction cycle. Depending on the value in the vector operation mask, the vector unit may determine whether or not to perform a computation on each of the elements in the source vector register. In one embodiment, if the vector unit performs a computation on a deselected element, the corresponding output or result of such a computation may be set to a predetermined value (e.g., zero).

In some embodiments, an operation may be performed on the source vector register, and then the vector operation mask may be set based on the results of the operation. For example, the numerically smallest elements of the source vector register may be identified, and then the vector operation mask may be set to select those elements for vector operations. Then, a subsequent computation may be performed by the vector unit with the vector operation mask restricting the computation to only those elements identified as the smallest elements.

In another embodiment, the mask may identify selected and deselected elements in other ways. For example, the mask may include a start element address and a stop element address. The start element address may indicate which element of a source register contains the first selected element, and the stop element address may indicate which element of the source vector register contains the last selected element. The start and stop addresses may each be represented by a fixed number of bits. A start and stop element address may be used in situations where a contiguous mask may be sufficient, such as when all of the selected elements are in contiguous locations within the source vector register. In further embodiments, the mask may be encoded as a start value plus a length. The start value may represent a start element address, and the length may correspond to a number of elements of the source vector register. In a still further embodiment, the mask may be encoded as a length, where the mask implicitly starts at the left or right end of the source vector register. Numerous such embodiments are possible and are contemplated.

The vector operation mask may affect both load and store vector operations. Typically, the result of a vector unit computation may be stored in a target vector register or a location in memory. The store operation, with the use of the mask, may store only the elements for which the mask is selected.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1A is a prior art block diagram of a scalar processor.

FIG. 1B is a prior art block diagram of a vector processor.

FIG. 2 illustrates one embodiment of a vector unit and associated registers.

FIG. 3 is a block diagram that illustrates a vector unit in accordance with one or more embodiments.

FIG. 4 illustrates one embodiment of a vector unit with a four-operand vector instruction architecture.

FIG. 5 illustrates one embodiment of a vector operation apparatus.

FIG. 6 is a generalized flow diagram illustrating one embodiment of a method for performing vector operation masking

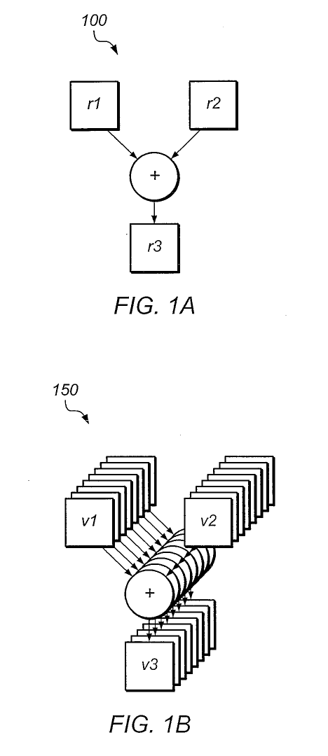

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

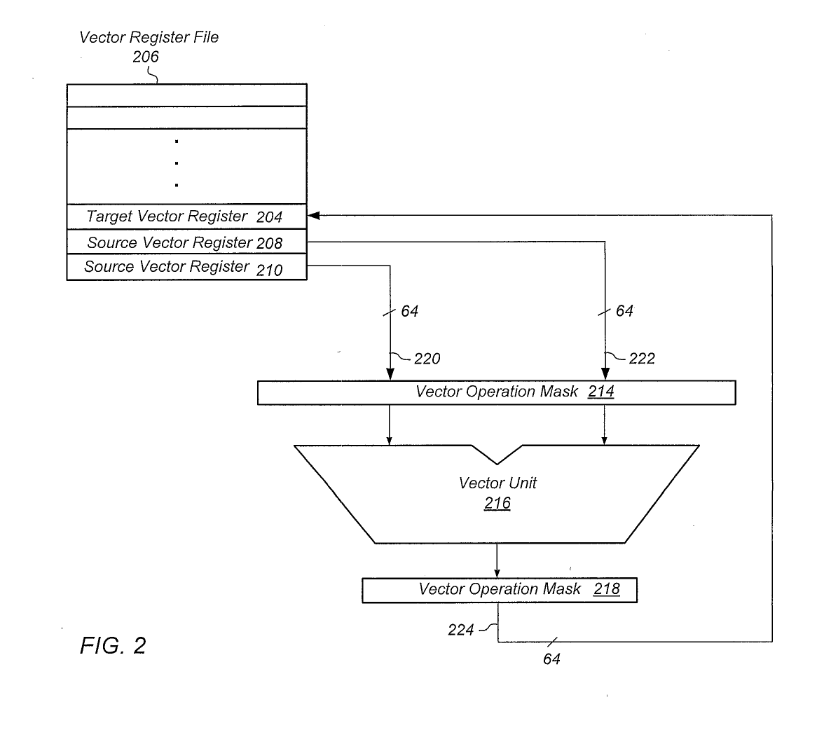

Referring to FIG. 2, a generalized block diagram of one embodiment of a vector unit and associated registers is shown. Vector unit 216 may be configured to execute single-instruction multiple-data (SIMD) instructions. Vector unit 216 may also be referred to as a vector computation unit, a vector arithmetic logical unit, a vector execution unit, a SIMD execution unit, or other similar terms. Vector unit 216 may perform logical and/or arithmetic operations on integers, floating point numbers, or other data. Vector unit 216 may also perform other types of operations, such as comparative, mathematical, functional, or otherwise, on the elements of source vector registers 208 and 210. The results of an operation performed by vector unit 216 may be stored in target vector register 204. Data may be exchanged between vector register file 206 and memory (not shown) using load and store instructions. Vector register file 206 may have a plurality of read and write ports. Vector register file 206 may include source vector registers 208 and 210, target vector register 204, and additional registers (not shown).

Data paths 220 and 222 may connect source vector registers 208 and 210, respectively, to vector unit 216. In other embodiments, the architecture of vector unit 216 may include a different number of data paths. Data paths 220 and 222 may each have a width of 64 bits. In other embodiments, data paths 220 and 222 may have a different bit-width size. Data path 220 connects source vector register 208 to vector unit 216 (through mask 214), and data path 222 connects source vector register 210 to vector unit 216 (through mask 214). Registers 208 and 210 may transfer data via data paths 220 and 222 to vector unit 216 on each instruction cycle. In some embodiments, source vector registers 208 and 210 may be consolidated into a single source vector register.

For illustrative purposes, the size of source vector registers 208 and 210 is 64 bits. Target vector register 204 may also be a 64-bit register and may be used to store the output of the computation. In other embodiments, registers 204, 208 and 210 may have a different size than 64 bits. Data may be transferred between vector register file 206 and memory or another location, and vector register file 206 may store multiple registers of source data upon which vector unit 216 may perform computations in multiple instruction cycles. The operations may be arithmetic operations (e.g., multiplication, division, addition, subtraction, square root) and/or logical or other types of operations.

A logical depiction of vector operation mask 214 is shown in FIG. 2 to depict how mask 214 may be used during vector operations performed by vector unit 216. In some embodiments, vector operation mask 214 may not be used, and instead, the results of the operation may be masked by mask 218 to indicate which of the resultant elements from the operation are desired or relevant. As shown in FIG. 2, vector operation mask 214 may be placed between source vector registers (208 and 210) and vector logic unit 216. Mask 214 may include an indicator corresponding to each element of registers 208 and 210. In some embodiments, the indicator may be a single bit to represent the status of the corresponding element in registers 208 and 210. There may be a set of operations that are utilized to set vector operation mask 214. The operations may set a particular pattern of bit-values to a vector that can then be passed to vector operation mask 214. The bits of vector operation mask 214 may be software controllable.

Mask 214 may pass through only selected data of the occupied elements from registers 208 and 210 to vector unit 216. As used herein, “selected” data may refer to valid or active data or to data that is relevant for a specific operation. Any deselected elements may be converted by mask 214 to a do not care value, such as zero, or may be blocked. As used herein, “deselected” data may refer to invalid or inactive data or to data that is not relevant for a specific operation. Mask 214 may also contain AND logic gates or other circuitry to either pass through, modify, or block elements of the source vector registers.

Vector operation mask 218 may be placed in the data path between vector unit 216 and target vector register 204. Data may pass through mask 218 to target vector register 204 via data path 224. In one embodiment, data path 224 may have a bit-width of 64. Only results computed by vector unit 216 for selected or occupied elements from registers 208 and 210 may be transferred through mask 218 to register 204. In one embodiment, vector operation masks 214 and 218 may be different registers, although the same bit values may be loaded into each register. In another embodiment, vector operation masks 214 and 218 may be a single mask, and data may pass through the single mask on the input and/or output paths of vector unit 216. Those skilled in the art will appreciate that mask 218 may not necessarily be physically in the data path 224, but rather may be logically applied to data elements in a variety of ways. All such embodiments are contemplated.

In other embodiments, there may be more than two source vector registers and more than one target vector register. In addition, vector unit 216 may be capable of operating on more than two source operands in a single instruction cycle. The bit-length of registers 204, 208, and 210 may be increased to accommodate the increased processing capabilities of vector unit 216. In further embodiments, source registers 208 or 210 or target register 204 may reside in a register file other than the vector register file.

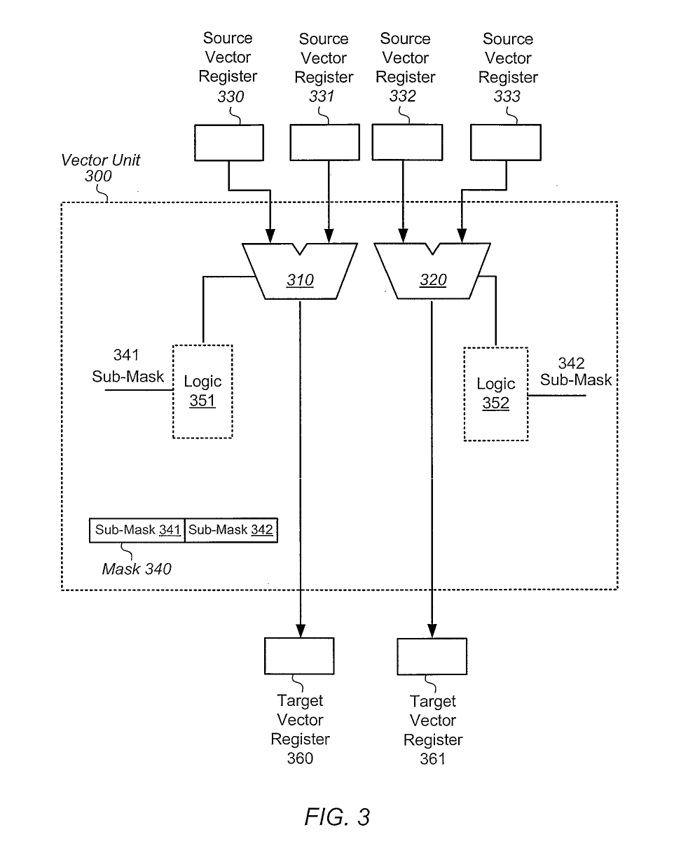

Referring now to FIG. 3, a block diagram of one embodiment of a vector unit is shown. Vector unit 300 includes two computing units 310 and 320. In other embodiments, vector unit 300 may include more than two computing units. Computing units 310 and 320 may receive the same control signals during the execution of vector instructions. Computing unit 310 may operate on data elements from source vector registers 330 and 331, and computing unit 320 may operate on data elements from source vector registers 332 and 333. In another embodiment, computing unit 310 may operate on a first portion of source vector registers 330 and 331, computing unit 320 may operate on a second portion of registers 330 and 331, and source vector registers 332 and 333 may be operated on in a later instruction cycle or by other computing units (not shown). Other allocations of source vector registers or portions of source vector registers to computing elements are possible and are contemplated.

In various embodiments, a computing unit may be configured to operate on different numbers of elements of a source vector register. For example, in one embodiment, each computing unit of a vector unit may operate on two element lanes. In another embodiment, each computing unit of a vector unit may operate on four element lanes, and so on. In a further embodiment, the same computing unit may be used for processing all of the input elements sequentially, one set of elements at a time, over multiple instruction cycles.

Vector operation mask 340 may be incorporated in vector unit 300, and mask 340 may include a bit for each element lane. In one embodiment, the logical OR of bits in sub-mask 341 may control (in part) logic “switch” 351 which may determine if power is supplied to computing unit 310. Similarly, the logical OR of bits in sub-mask 342 may be used to control logic 352 which may determine if power is supplied to computing unit 320. Logic 351 and 352 may comprise any suitable logic operable to enable or disable power to portions of the computing units 310 and 320. In some embodiments, enabling or disabling power may mean to enable or disable the functionality of the corresponding computation unit. In other embodiments, computation units may have varying power levels with which they may operate (e.g., low power which may provide reduced performance, high power which provides higher performance, and so on.). In such embodiments, enabling may refer to a higher power state while disabling may refer to a lower power state. All such alternative embodiments are contemplated. For example, switches 351 and 352 may adjust the power supplied to computing units 310 and 320 based on varying performance states. The bits of mask 340 may be configured by software. In one embodiment, mask 340 may be set by an external load and store unit (not shown). The results of computations executed by computing units 310 and 320 may be written to target vector registers 360 and 361, respectively.

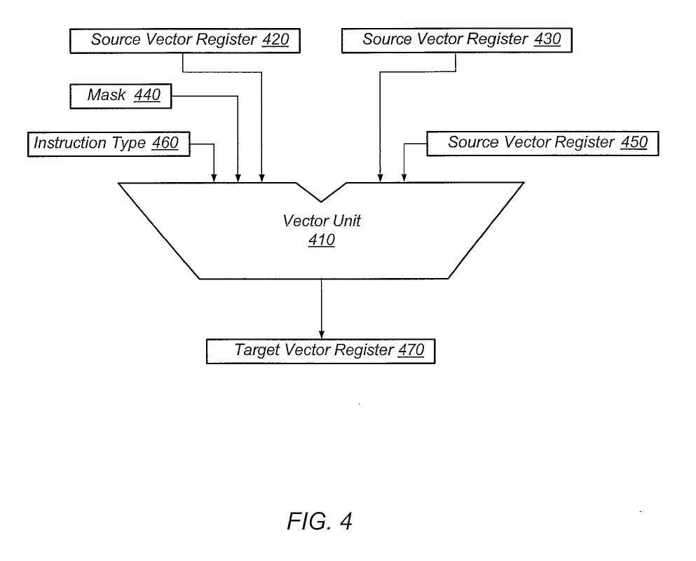

Referring now to FIG. 4, one embodiment of a vector unit with a four-operand vector instruction architecture is shown. In the vector unit architecture shown in FIG. 4, vector operation mask 440 may be a register which is passed to vector unit 410 during each instruction cycle. The actual instruction being performed (e.g., multiplication, addition) may be passed from instruction type register 460 to vector unit 410. In another embodiment, mask 440 may be implied by the instruction received or read from instruction type register 460, such that vector unit 410 may read mask 440 after determining the requested instruction.

Source vector registers 420, 430, and 450 may be passed as inputs to vector unit 410 during each instruction cycle. Source vector registers 420, 430, and 450 may be any size of registers containing any number of bits; the number of bits is typically a power of two, though not necessarily so. In other embodiments, the elements of any combination of registers 420, 430, and 450 may be stored in a single source vector register. Instruction type 460 may also be passed to vector unit 410. Instruction type 460 may include a bit pattern or code to indicate the requested instruction. A location or address of target vector register 470 may also be passed to vector unit 410, specifying where the result of the operation should be written by vector unit 410.

In one embodiment, vector operation mask 440 may include an indicator (e.g., a single bit) for each element of source vector registers 420, 430, and 450, and the element size of registers 420, 430, and 450 may be one byte. In other embodiments, a bit in mask 440 may correspond to a size other than one byte. The bit pattern of mask 440 may be set to indicate which elements of source vector registers 420, 430, and 450 are filled with selected data and should be operated on. Vector unit 410 may use the bit-values of mask 440 to turn off the individual computing units associated with the deselected elements of source vector registers 420, 430, and 450. After vector unit 410 performs the requested operation, the result may be written to target vector register 470. In another embodiment, vector unit 410 may perform the operation on the deselected elements of registers A and B, but vector unit 410 may not write the results of the operation of the deselected elements to target vector register 470. In a further embodiment, vector unit 410 may perform the operation on the deselected elements of registers A and B, but prevent any exceptions from being set by operations performed on the deselected elements.

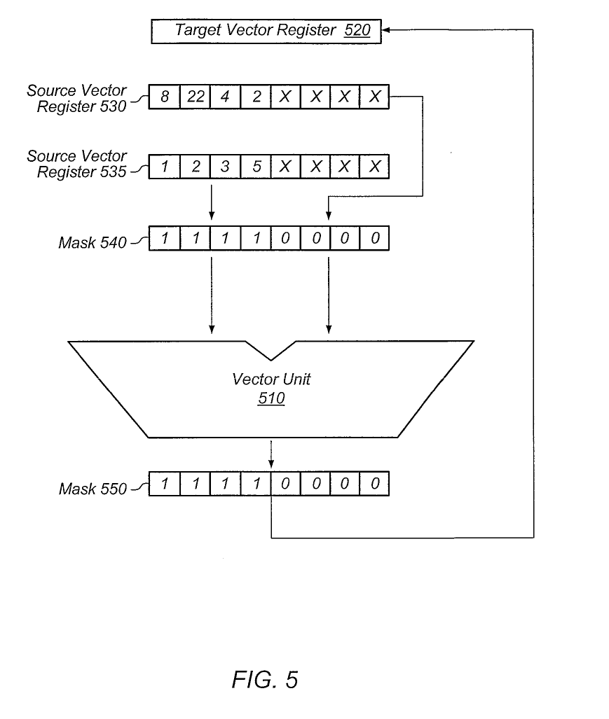

Turning now to FIG. 5, one embodiment of a vector operation apparatus is shown. A logical depiction of vector operation masks 540 and 550 is shown in FIG. 5. The logical depiction displays how masks 540 and 550 may be used to filter the loading and storing of data to and from vector unit 510. Source vector register 530 is shown containing the element pattern “8-22-4-2-X-X-X-X”, and source vector register 535 is shown containing the element pattern “1-2-3-5-X-X-X-X”. The ‘X’ refers to deselected or “don't care” elements, and as shown, source vector registers 530 and 535 are only partially filled with selected or relevant data elements. The last four elements of registers 530 and 535 are deselected or “don't care” elements, which may be due to the actual source data vector containing only two sets of four elements. It is noted that a particular element referred to as “deselected” or “don't care” may actually contain valid data, but it may be determined that an operation should not be performed on that particular element.

The bit pattern of vector operation mask 540 matches the alignment of data in registers 530 and 535, with a bit-value of ‘1’ where the corresponding elements of registers 530 and 535 are selected, and with a bit-value of ‘0’ where the corresponding elements of registers 530 and 535 are deselected. In other embodiments, the assignments of bit-values to the mask may be reversed, with a bit-value of ‘1’ indicating deselected and a bit-value of ‘0’ indicating selected. Mask 550 also contains the same pattern as mask 540. Masks 540 and 550 may be set during the same mask-loading operation, and masks 540 and 550 may both have the same pattern of bits to reflect the location of selected and deselected elements in source vector registers 530 and 535. In one embodiment, only mask 550 may be used to mask the results of operations performed by vector unit 510. In another embodiment, masks 540 and 550 may be the same physical mask. In a further embodiment, masks 540 and 550 may contain values that differ.

In one embodiment, mask 540 may operate by performing a logical AND operation on the elements of source vector registers 530 and 535 before the data elements of registers 530 and 535 are passed as inputs to vector unit 510. If there is a ‘1’ bit in mask 540, then for each source register, the result of the AND operation will be the value of the corresponding element in that source register. If there is a ‘0’ bit in mask 540, then the result of the AND operation for the corresponding element will have a ‘0’ value. A similar circuit or function may be implemented in mask 550 to filter the values that are output from vector unit 510 before they are written to target vector register 520. Also, for floating point operations, any exceptions that are generated may be filtered by mask 550, such that any exceptions generated for deselected elements may be ignored or blocked. Mask 550 may prevent any operations from being flagged as exceptions for the deselected elements of registers 530 and 535. In another embodiment, the deselected data elements in source vector registers 530 and 535 may be set to ‘0’ or another predefined value. In a further embodiment, for floating point operations, prior to vector unit 510 performing a computation, the values of deselected data elements in registers 530 and 535 may be set to values that do not cause exceptions.

In another embodiment, an operation may be performed by vector unit 510 on the elements from source vector register 530 (and/or register 535), and then masks 540 and 550 may be set based on the results of the operation. For example, the numerically smallest elements of source vector register 530 may be identified, and then masks 540 and 550 may be set to enable only the smallest elements of register 530. Then, a subsequent computation may be performed on source vector register 530 by vector unit 510 with mask 540 restricting the computation to only those elements identified as the smallest elements, and mask 550 restricting the writing of the output of the computation to target vector register 520 of only those elements.

In a further embodiment, masks 540 and 550 may include a start element address and a stop element address. The start element address may indicate which element of registers 530 and 535 contains the first selected element, and the stop element address may indicate which element of registers 530 and 535 contains the last selected element. The start and stop element addresses may each be represented by a fixed number of bits. Start and stop element addresses may be used in situations where a contiguous mask may be sufficient, such as when all of the occupied elements are in contiguous locations within source vector registers 530 and 535. For the example shown in FIG. 5, masks 540 and 550 may include a start element address of ‘000’, corresponding to the first element of registers 530 and 535, and a stop element address of ‘011’, corresponding to the fourth element of registers 530 and 535. Other techniques of representing the start and stop element addresses are possible and are contemplated.

As noted above, each of masks 540 and/or 550 may be encoded as a start value plus a length. The start value may represent a start element address, and the length may correspond to a number of elements of the source vector registers. In a still further embodiment, each of masks 540 and/or 550 may be encoded as a length, where the mask implicitly starts at the left or right end of the source vector registers.

In a still further embodiment, there may be more than one bit of masks 540 and 550 that correspond to each element in source vector registers 530 and 535. For example, as shown in FIG. 5, there may be a bit in masks 540 and 550 for each integer of source vector registers 530 and 535. Each integer may take up four bytes in registers 530 and 535. In a later vector operation, double-precision floating point numbers may be stored in registers 530 and 535, with an element size of eight bytes. In this case, masks 540 and 550 will have two bits for each element of registers 530 and 535, and one of the bits will be redundant. In this embodiment, the first of the two bits may determine if the corresponding element in registers 530 and 535 is masked. The first bit of each pair of contiguous bits of masks 540 and 550 may be set based on the selection or deselection of the corresponding element in source vector registers 530 and 535, and the second bit of each pair may be ignored by vector unit 510 and/or any other software or hardware processing unit which reads masks 540 and 550. In another embodiment, another of the redundant bits, other than the first bit, may serve as the “element selection” bit for longer elements.

In some embodiments, masks 540 and 550 may be a single vector operation mask. A single unit (not shown) may implement load and store operations; this single unit may load vector unit 510 from source vector registers 530 and 535 and store results in target vector register 520. A single mask may allow the load and store unit to implement the masking functions affecting load and store operations. Alternatively, a single mask may mask functions affecting store operations. In other embodiments, masks 540 and 550 may contain values that differ. In addition, one mask may correspond to load operations and the other mask may correspond to store operations. Alternatively, either mask 540 or mask 550 may correspond to both load and store operations, and the other mask may correspond to other operations.

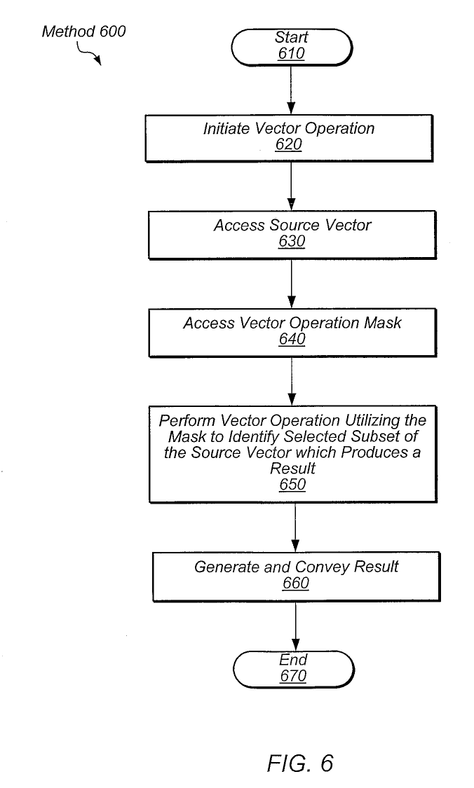

Turning now to FIG. 6, one embodiment of a method for masking vector operations is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired.

The method 600 starts in block 610, and then in block 620, a vector operation is initiated. The vector operation may be initiated by a vector unit and/or a processor coupled to the vector unit. Next, the vector unit may access a source vector in block 630. The source vector may include a plurality of elements. In some embodiments, the source vector may be a stored in a register. Then, the vector unit may access a vector operation mask in block 640. The vector operation mask may include a corresponding indicator for each of the plurality of elements of the source vector. The indicators of the vector operation mask may be bits, and the values of the bits may be set based on the pattern of selected and deselected elements in the source vector.

Next, a vector operation may be performed by utilizing the vector operation mask to identify a selected subset of the plurality of elements of the source vector which may be used to produce a desired result (block 650). The vector operation may be an arithmetic or logical operation. In one embodiment, the operation may be performed on a subset of the plurality of elements of the source vector. The bit-values in the vector operation mask may determine on which of the subset of elements the operation is performed. In another embodiment, the vector operation mask may be passed to the vector unit as an input during an instruction cycle. In a further embodiment, the vector operation mask may be stored in a register whose location is implied. In a still further embodiment, the vector unit may include a plurality of computing units, and whether power is enabled or disabled to each of the computing units may be determined based on the corresponding bit-values of the vector operation mask.

After block 650, a result may be generated and conveyed to a target vector register (block 660). The bit-values in the vector operation mask may determine a subset of the plurality of result elements which are conveyed to the target vector. In one embodiment, any exceptions generated for deselected elements may be ignored. Elements may be identified as being deselected by the corresponding bit-value in the vector operation mask. After block 660, the method may end in block 670.

It is noted that the above-described embodiments may comprise software. In such an embodiment, program instructions and/or a database (both of which may be referred to as “instructions”) that represent the described methods and/or apparatus may be stored on a computer readable storage medium. Generally speaking, a computer readable storage medium may include any storage media accessible by a processor during use to provide instructions and/or data to the processor. For example, a computer readable storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM)), ROM, or non-volatile memory (e.g. Flash memory). Such media may be accessible locally to the processor or via a peripheral interface such as the PCIE interface, USB interface, etc. Storage media may include micro-electro-mechanical systems (MEMS), as well as storage media accessible via a communication medium such as a network and/or a wireless link.

Although several embodiments of approaches have been shown and described, it will be apparent to those of ordinary skill in the art that a number of changes, modifications, or alterations to the approaches as described may be made. Changes, modifications, and alterations should therefore be seen as within the scope of the methods and mechanisms described herein. It should also be emphasized that the above-described embodiments are only non-limiting examples of implementations.

What is claimed is:

1. An apparatus comprising:
a vector unit, one or more source vectors, and a vector operation mask, wherein each of the one or more source vectors comprises a plurality of N elements, and wherein the vector operation mask comprises a corresponding selection indicator for each of the plurality of N elements;
wherein the vector unit is configured to perform an operation on the one or more source vectors; and
wherein the vector operation mask identifies which of a subset of the plurality of N elements of each of the one or more source vectors are used in the operation to produce a desired result.

2. The apparatus as recited in claim 1, wherein the vector unit performs the operation on a subset of the plurality of N elements of the one or more source vectors, and wherein the indicators in the vector operation mask determine on which of the subset of elements the operation is performed.

3. The apparatus as recited in claim 1, wherein the vector operation mask is either passed to the vector unit as an input during an instruction cycle, or is stored in a register whose location is implied.

4. The apparatus as recited in claim 1, wherein each indicator of the vector operation mask is a single bit, and wherein each element of the plurality of N elements of the one or more source vectors is one or more bits.

5. The apparatus as recited in claim 1, wherein the vector unit comprises a plurality of computing units, and wherein each of the indicators of the vector operation mask are used to enable or disable power to each of the plurality of computing units.

6. The apparatus as recited in claim 1, wherein exceptions corresponding to elements of the plurality of N elements other than said subset are ignored.

7. The apparatus as recited in claim 1, wherein the operation is an arithmetic, logical, load, or store operation.

8. A method for executing a vector operation, the method comprising:
initiating a vector operation;
accessing one or more source vectors, wherein each of the one or more source vectors comprises a plurality of N elements;
accessing a vector operation mask, wherein the vector operation mask comprises a corresponding selection indicator for each of the plurality of N elements of the one or more source vectors;
utilizing the vector operation mask to identify which of a subset of the plurality of N elements of the one or more source vectors are used to produce a desired result; and
generating and conveying a result of the vector operation.

9. The method as recited in claim 8, wherein the vector unit performs the vector operation on a subset of the plurality of N elements of each of the one or more source vectors, and wherein the indicators in the vector operation mask determine on which of the subset of the plurality of N elements the operation is performed.

10. The method as recited in claim 8, wherein the vector operation mask is either passed to the vector unit as an input during an instruction cycle, or is stored in a register whose location is implied.

11. The method as recited in claim 8, wherein each indicator of the vector operation mask is a single bit, and wherein each element of the plurality of N elements of the one or more source vectors is one or more bits.

12. The method as recited in claim 8, wherein the vector unit comprises a plurality of computing units, and wherein each of the indicators of the vector operation mask are used to enable or disable power to each of the plurality of computing units.

13. The method as recited in claim 8, wherein exceptions corresponding to elements of the plurality of N elements other than said subset are ignored.

14. The method as recited in claim 8, wherein the vector operation is an arithmetic, logical, load, or store operation.

15. A computer readable storage medium comprising program instructions to execute a vector operation, wherein when executed the program instructions are operable to:
initiate a vector operation;
access one or more source vectors, wherein each of the one or more source vectors comprises a plurality of N elements;
access a vector operation mask, wherein the vector operation mask comprises a corresponding selection indicator for each of the plurality of N elements of the one or more source vectors;
utilize the vector operation mask to identify which of a subset of the plurality of N elements of the one or more source vectors are used to produce a desired result; and
generate and convey a result of the vector operation.

16. The computer readable storage medium as recited in claim 15, wherein the vector unit performs the vector operation on a subset of the plurality of N elements of each of the one or more source vectors, and wherein the indicators in the vector operation mask determine on which of the subset of the plurality of N elements the operation is performed.

17. The computer readable storage medium as recited in claim 15, wherein the vector operation mask is either passed to the vector unit as an input during an instruction cycle, or is stored in a register whose location is implied.

18. The computer readable storage medium as recited in claim 15, wherein each indicator of the vector operation mask is a single bit, and wherein each element of the plurality of N elements of the one or more source vectors is one or more bits.

19. The computer readable storage medium as recited in claim 15, wherein the vector unit comprises a plurality of computing units, and wherein each of the indicators of the vector operation mask are used to enable or disable power to each of the plurality of computing units.

20. The computer readable storage medium as recited in claim 15, wherein exceptions corresponding to elements of the plurality of N elements other than said subset are ignored.
